(19) United States
(12) Patent Application Publication
(10) Pub. No.: US 2012/0090156 A1
(43) Pub. Date: Apr. 19, 2012

(54) CONSTRUCTION SYSTEM AND METHOD UTILIZING CD AND OTHER ELECTRONIC MEDIA CASES

(76) Inventor: Harrison Joshua Jackson, Baltimore, MD (US)

(21) Appl. No.: 13/273,063

(22) Filed: Oct. 13, 2011

Related U.S. Application Data
(60) Provisional application No. 61/392,561, filed on Oct. 13, 2010.

(51) Int. Cl. F16B 17/00; B23P 11/00

(52) U.S. Cl. 29/525.01; 403/345

(57) ABSTRACT

A construction system for joining a plurality of CD cases comprising a plurality of component clips, wherein each component clip defines a front recess formed by a front upper arm, a front lower arm and a front support back connecting the two front arms, wherein the front arms are generally parallel; and wherein each clip further defines a groove on each of the two front arms adjacent to the support back within the front recess. A method of using a component clip comprising the steps of orienting the component clip and a CD case such that the CD case is adjacent but not within a first recess; and sliding the CD case into the first recess so that at least one lip on the CD case is received in one of the grooves in two opposing arms.

### CROSS REFERENCE TO RELATED APPLICATIONS

This application claims the benefit of the filing date of U.S. provisional patent application Ser. No. 61/392,561, filed on Oct. 13, 2010, by the present inventor, the entirety of which is incorporated herein by reference for all purposes.

### FIELD OF THE INVENTION

The present invention relates to useful and artistic construction systems similar to modular panel storage systems and toy building sets. More specifically, the present invention relates to systems incorporating electronic (and magnetic) media cases. In addition, the present invention addresses, but is not limited to, systems compatible with standard compact disc (CD) jewel cases.

### BACKGROUND

Since the mid-1980's, compact discs (CDs) have been delivered and stored in clear jewel cases. The jewel case provides necessary strength to protect a CD, allows convenient access to remove a CD via a hinged cover, and is clear to allow ready viewing of the content and album artwork, etc. In addition, while variations of the design have evolved over the years, including wider cases to store multiple CDs and slim cases for more compact storage of a single CD, a standard design has proliferated the global market with little to no variation in exterior dimensions, physical strength, or overall transparency. This has likely been driven by a compounding need for consistency by both the user (home user, retail store, etc.), who invests in a storage device sized for standard case designs, and the CD case manufacturers, who aim to continually meet the user's storage needs.

Capitalizing on the standard shape and size of a CD jewel case, several useful and artful devices have been created providing ready storage, positioning, and/or semi-permanent display. In most instances, the devices conveniently snap onto or into the CD case and allow a predominantly un-interrupted view of one of the case's large front faces. In other instances, the devices also allow for the hinged case cover to open, granting easy access to the CD contained inside without removing the case from the holder device. In yet another variation, the device also snaps onto another device, providing a means to assemble a plurality of case storage devices in limitless three dimensional construction modes (Erickson, U.S. Pat. No. 5,474,170). However, the primary disadvantage with this and other aforementioned devices is the failure to recognize and utilize the strength of the case, thereby significantly reducing the volume of holder device. In addition, none of the aforementioned CD case holder devices make use of a snap fit spanning only the thinnest portion of the case. Along most edges of a standard CD jewel case exists a small but tangible lip, providing a means for establishing a very small, but sturdy, snap-on clip to securely grip the case. This feature, based on a review of a prior art, has neither been acknowledged nor utilized in this manner Accordingly, a holding device is envisioned that, by friction and/or positive locking via a snap-fit, securely grips a CD jewel case and, by additional features disclosed herein, can also grip at least one other case and/or contains means to readily attach to another holder device.

Since the advent of digital media storage, in particular audio storage and playback in a digital format, the demand for playing traditional CDs has diminished. As such, the need to access CDs within CD cases has diminished. Based on this change in traditional CD case functional requirements, a holder device is envisioned that preferably optimizes holder size and shape without regard for allowing convenient access to the CD case contents.

Regarding toy construction sets and modular storage systems, these generally contain all the pieces necessary to assemble a given structure. However, these sets generally fail to incorporate or reuse common household, office, school, etc. objects, such as standard CD jewel cases, for which an abundance likely already exists in the community and for which use in its originally-intended role is no longer needed.

### BRIEF SUMMARY OF THE INVENTION

In a first aspect, the present invention comprises a construction system for joining a plurality of CD cases comprising: a plurality of component clips, wherein each component clip defines a front recess formed by a front upper arm, a front lower arm and a front support back connecting the two front arms, wherein the front aims are generally parallel; and wherein each clip further defines a groove on each of the two front arms adjacent to the support back within the front recess. Additionally, each of the grooves may be dimensioned to receive a raised lip on an edge of the CD case and the distance between the two front arms may span a dimension of the CD case. Further, each of the front upper arm and the front lower arm may define a generally circular aperture.

In accordance with yet another aspect of the construction system of the present invention, each of the two parallel arms may further comprise opposing generally axial-symmetric apertures, the apertures sized to receive a generally spherical ball having a nominal diameter slightly larger than the dimension of the CD case.

In yet another aspect of the construction system of the present invention, each clip may further define a rear recess, wherein the rear recess is defined by an upper rear arm and a lower rear arm generally parallel to each other and an opposite side of the front support back and wherein each of the upper and lower rear arms defines a groove adjacent to the opposite side of the front support back within the rear recess; wherein the front upper arm is in the same plane as the rear upper arm; the front lower arm is in the same plane as the lower rear arm; and wherein the distance between the two rear arms spans the dimension of the CD case.

In yet a further aspect of the construction system of the present invention, each clip may further define a rear recess, wherein the rear recess is defined by an upper rear arm and a lower rear arm generally parallel to each other and a rear support back; wherein each of the upper and lower rear arms defines a groove on each of the rear arms adjacent to the rear support back within the rear recess; the rear support back extends perpendicular to the front support back; the rear support back extends parallel to the front upper arm; and the rear upper arm integral with a portion of the front support back; and wherein the distance between the two rear arms spans the dimension of the CD case.

In another aspect of the construction system of the present invention, each clip may further define a third recesses; the third recess formed by a third upper arm extending outwardly from the front upper arm, a third lower arm extending outwardly from the rear upper arm, and a third back formed from portions of the front upper arm and rear upper arm; the third arms being disposed parallel to the front support back; wherein each of the third arms defines a groove adjacent to front upper arm and rear upper arm within the third recess; and wherein the distance between the two third arms spans the dimension of the CD case.

In yet another aspect of the construction system of the present invention, each clip may further define a ball on a stem wherein the stem extends outwardly from the clip; and the ball having a nominal diameter slightly larger than the dimension of the CD case. Additionally, the ball is generally spherical in contour and such generally spherical contour is broken by five orthogonal slices. Further, the ball may define four cylindrical apertures each of which being orthogonal to the stem, the axes of the cylindrical apertures extending through the center of the ball; and the ball has a fifth circular aperture opposite the stem. Also, the generally spherical contour may further comprise multiple raised surfaces.

In another aspect, the present invention comprises a construction and CD case system, comprising: a generally cubic assembly of six CD cases assembled by at least one component clip along each of twelve edges of the cubic assembly, each component clip defining two orthogonal recesses, each recess having frictional means integral to the recess able to releasably seize raised lips found on two opposing edges of each CD case.

In yet a further aspect, the present invention comprises a method of using a component clip, the method comprising the steps of: orienting the component clip and a CD case, the component clip having a first recess formed by two opposing parallel arms and a support back connecting the two opposing arms, a groove on each of the two opposing arms, the grooves adjacent to the support back, such that the CD case is adjacent but not within the first recess; and sliding the CD case into the first recess so that at least one lip on the CD case is received in one of the grooves.

In yet an additional aspect, the present invention comprises a construction system to join CD cases, the system comprising component clips having at least one CD recess; the at least one CD recess having frictional holding means to releasably grip a raised lip on the CD case. Further, the frictional holding means may include at least two grooves within the at least one CD recess and each of the component clips may define two opposing generally axial-symmetric apertures, the apertures sized to receive a generally spherical ball having a nominal diameter slightly larger than a dimension of the CD case. Additionally, each of component clips may further comprise a ball on a stem; the stem extending outward from the component clip; and the ball having a nominal diameter slightly larger than the dimension of the CD case.

In another aspect of the construction system of the present invention, the ball may define four cylindrical apertures each of which being orthogonal to the stem, the axes of the cylindrical apertures extending through the center of the ball; and the ball has a fifth circular aperture opposite the stem. Further, the ball may have a generally spherical contour and multiple raised surfaces.

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 is a perspective view of a preferred embodiment of a removably attachable clip of the present invention with means to attach to two opposing CD cases such that the case faces are primarily co-planar when fully secured.

FIG. 1A is a side view of the attachable clip of FIG. 1.

FIG. 2 is a perspective view of another preferred embodiment of a removably attachable clip of the present invention with means to attach to two opposing CD cases such that the case faces are primarily perpendicular and two case edges are primarily aligned when fully secured.

FIG. 2A is a side view of the removably attachable clip of FIG. 2.

FIG. 3 is a perspective view of yet another preferred embodiment of a removably attachable clip of the present invention with means to attach to three opposing CD cases such that the case faces of two cases are primarily co-planar when secured and a third case is primarily perpendicular to the first two cases when fully secured.

FIG. 3A is a side view of the removably attachable clip of FIG. 3.

FIG. 4 is a perspective view of an additional preferred embodiment of a removably attachable clip of the present invention with means to securely attach to one CD case and means to adjustably mate with one other clip.

FIG. 4A is a side view of the fourth removably attachable clip of FIG. 4.

FIG. 4B is a top view of the fourth removably attachable clip of FIG. 4.

FIGS. 5A, 5B, 5C, 5D, and 5E are perspective views of additional and alternative preferred embodiments of removably attachable clips with capabilities similar to the removably attachable clips of FIGS. 1, 2, 3, and 4, but with alternative construction advantages.

FIG. 6 is a perspective view of the first removably attachable clip of FIG. 1 in relation to a standard CD jewel case showing the preferred assembly orientation.

FIG. 6A is a cross-section view of the first removably attachable clip of FIG. 1 fully secured to a standard CD jewel case.

FIG. 7 is a top view of two standard CD jewel cases physically secured by the removably attachable clip of FIG. 1.

FIG. 8 is a perspective view of an open-ended box constructed from five standard CD jewel cases and eight of the removably attachable clips of FIG. 2.

FIG. 8A is a side view of the open-ended box of FIG. 8.

FIG. 9 is a front view of collapsible wall panel constructed from CD cases and an assortment of clips of the present invention shown herein.

### DETAILED DESCRIPTION OF PREFERRED EMBODIMENT(S) OF THE INVENTION

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense, and the scope of the inventive subject matter is defined by the appended claims and their equivalents.

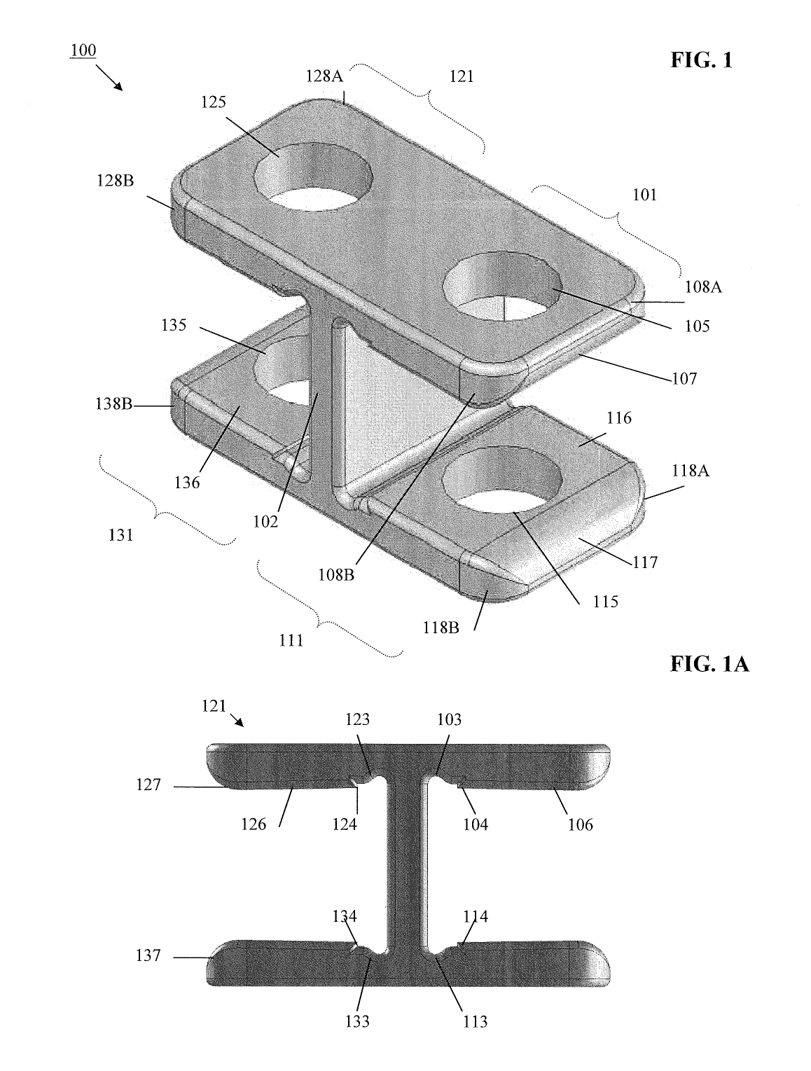

FIGS. 1 and 1A show a first removably attachable clip 100 with means to attach to two opposing CD cases such that the case faces are primarily co-planar when fully secured. The preferred embodiment shows an I-beam-like arrangement with a plurality of arms, a back, and other associated features discussed herein. Although identified as individual elements of the preferred embodiment, the clip 100 is preferably of uniform and solid construction. Further, the clip 100 is constructed of a flexible yet sturdy material, preferably a grade of thermoplastic.

FIG. 1 shows a plurality of arms 101, 111, 121, and 131 extending from a central support back 102. Although not a requirement, for ease of design and manufacturability, as well as for aesthetic appeal, each arm is identical in size and shape. Further, each arm is attached to the back 102 by an identically configured joint. Specifically, arm 101 attaches to back 102 at joint 103, arm 111 attaches via joint 113, arm 121 attaches via joint 123, and arm 131 attaches via joint 133. During attachment of the clip 100 to a CD case, minis 101 and 111 will splay away from each other. Accordingly, joints 103 and 113 are preferably designed with radii to minimize the stress concentrations at these locations. The same geometry is incorporated at joints 123 and 133.

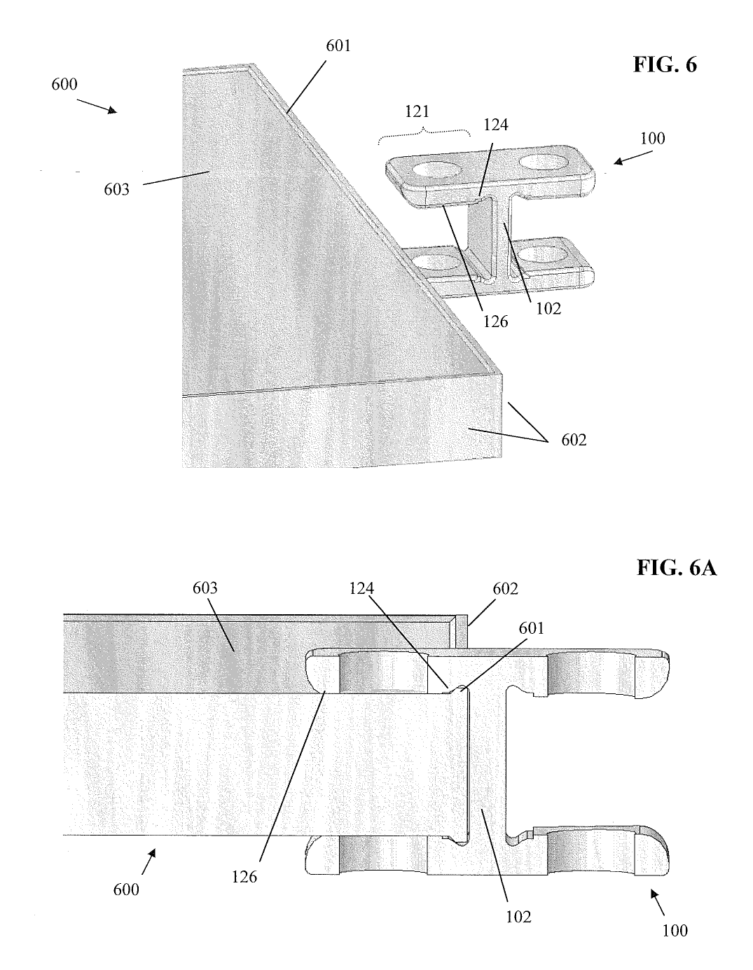

One method of CD case retention by clip 100 is a snap-fit whereby an arm 101 and the back 102 exert a force on the lip of material found on most standard CD jewel case edges. In FIGS. 6 and 6A, clip 100 attaches to CD case 600. When fully engaged, back 102 contacts one of four CD cases surfaces 602. On arm 121 the retention force is then applied by edge 124 on the case lip 601, locking the case in position against the back 102. Another method of CD case retention is friction between the arms and the face of the CD case. Per FIG. 1 or 6, flat 126 will engage face 603 while edge 124 is engaged with lip 601. This is accomplished by gradually sloping the position of flat 126 away from edge 124 such that the angle fowled by flat 126 and back 102 is slightly less than 90 degrees. Although not shown in FIG. 1 or 6, the flats could be altered to increase the amount of friction, possibly by application of rubber or a similar coating or component. At least two methods of CD case retention are envisioned to be provided in the preferred embodiment to ensure optimal attachment despite the slight differences in standard CD jewel case geometries that may make one or another attachment method less effective.

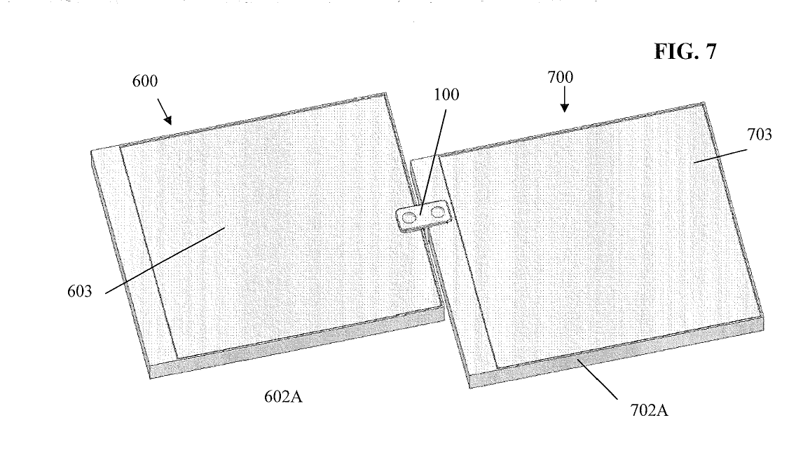

In FIG. 7, clip 100 is shown fully engaged and joining two CD cases, 600 and 700, such that the case faces, 603 and 703, are primarily co-planar. In addition, FIG. 7 shows that the case surfaces 602A and 702A can be offset to any desired position or made co-planar while maintaining clip 100 attachment relationship. FIG. 7 also displays the relative size of clip 100 with respect to a standard CD jewel case 600. While it is envisioned that one clip 100 can satisfy basic structural and artistic design features in a constructed assembly, multiple clips 100 can be assembled along the same case surfaces providing additional strength, stability, and/or aesthetic appeal.

Facilitating insertion and removal of a CD case, each arm is equipped with a gradual lead-in geometry to the flat. For example, in FIG. 1A, aim 121 consists of a curved lead-in 127 to flat 126. This feature may also be primarily flat and/or altered in length in other modes of the present invention. In addition, arm 121, and the other arms, may also be altered in length and width from the preferred scale shown in FIG. 1 in order to optimize flexibility, frictional resistance, aesthetic appeal, etc. The arm shape, primarily rectangular, may also be altered to other polygons, circles, or to mimic outlines of common household, office, or everyday items and/or animals and other natural forms.

Regarding the flats, an alternate mode of the present invention is incorporation of a gradual area of removed material along the arm length to introduce extra flexibility in the vicinity of the lead-ins. For example, in FIG. 1A, removed material could consist of a arc or radius from near edge 134 to lead-in 137, however preserving a minimal amount of flat 136 near the edge 134 and/or lead-in 137 to ensure frictional resistance with the CD case.

Regarding FIG. 1, back 102 is shown as rectangular and primarily flat across the length and height. In an alternate version of the present invention, this feature could incorporate minimally arced or sloped portions to maximize contact force on CD case surfaces which are not entirely flat. This feature may also be altered in shape similar to alternate geometries envisioned for arm shapes, as well incorporate one or more hollowed sections.

Per FIG. 1, each arm is configured with a preferably circular hole. On arm 101, hole 105 is centered across the clip 100 width and in addition is concentrically aligned with hole 115 on arm 111. The holes reduce the amount of material needed for construction since the locations are not substantially loaded during assembly with, retention with, or disassembly from CD cases. In addition, the holes provide means for alternately displaying or securing one CD case (and any other cases it may be attached to). For example, with one CD case secured between arms 121 and 131, holes 105 and 115 can be used to readily hang the case, perhaps as wall art, using a nail or screw or similar means inserted into one or both holes. Likewise, a rod or string or similar means can be used to stack, hang, or otherwise semi-permanently bundle multiple cases for ready display, transport, etc.

One pair of concentrically-aligned holes, such as 105 and 115, also provides a means for assembling clip 400 in a ball-and-socket configuration. Therefore, using an assembly consisting of clip 100 and clip 400, two CD cases can be joined and rotated in an indefinite number of positions. In this mode, per FIG. 1, radii are added to the ends of the clip 100 arms to preclude interference with clip 400 back 402. Specifically, arm 101 is equipped with radii 108A and 108B, and so on for the remaining arms.

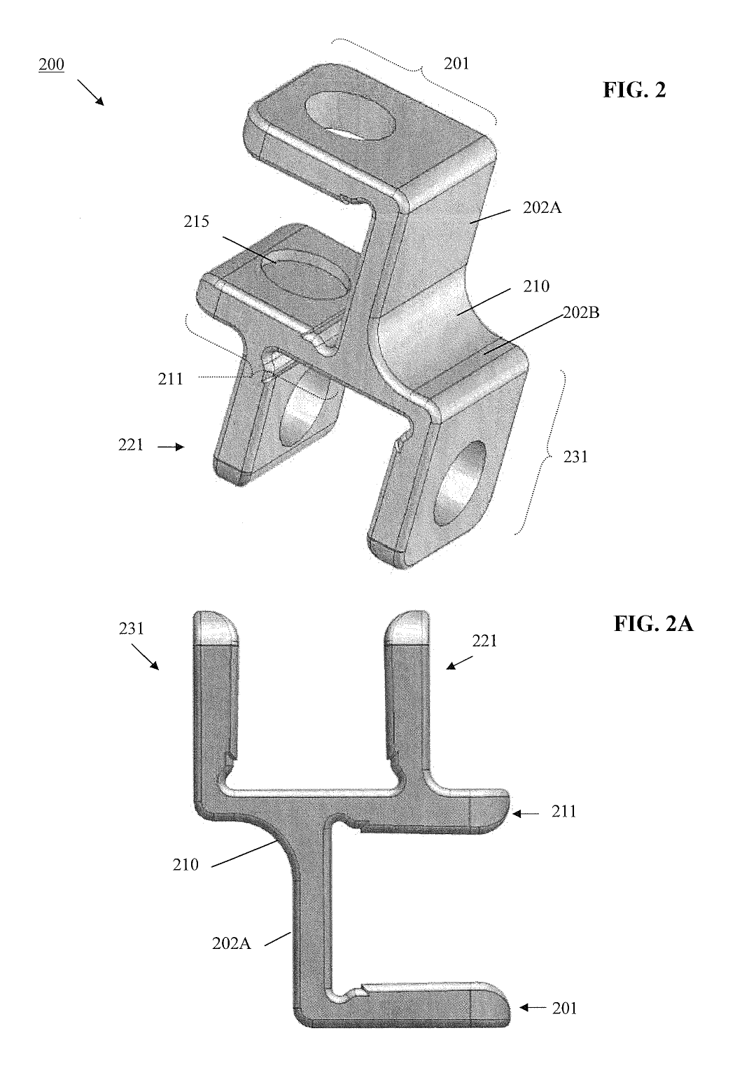

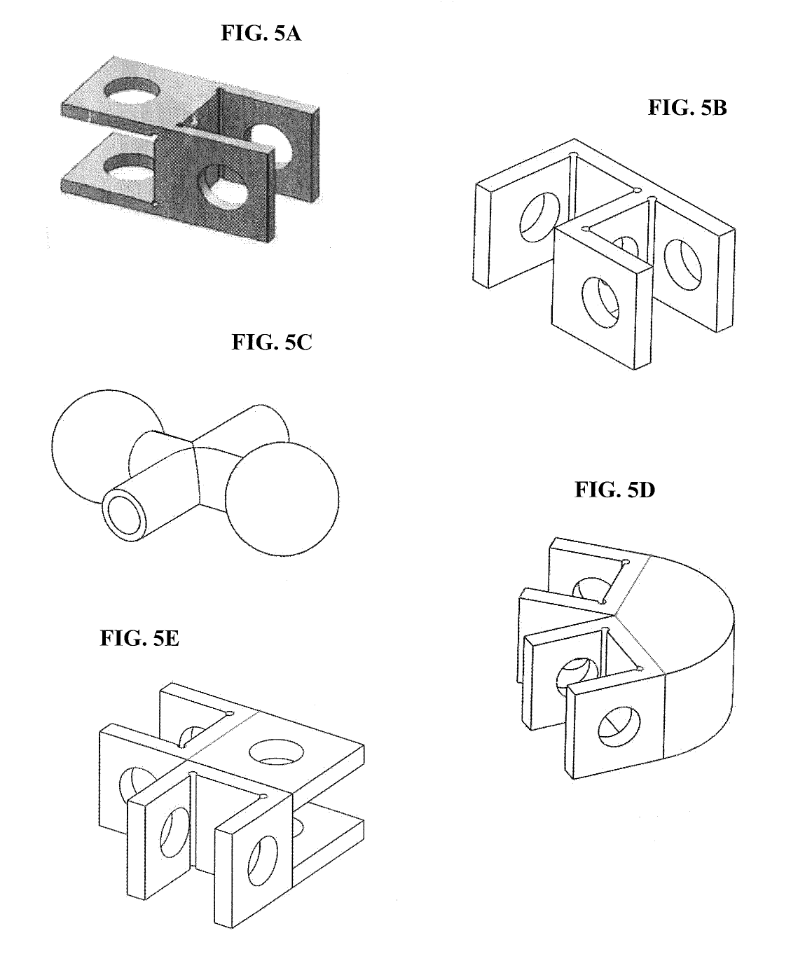

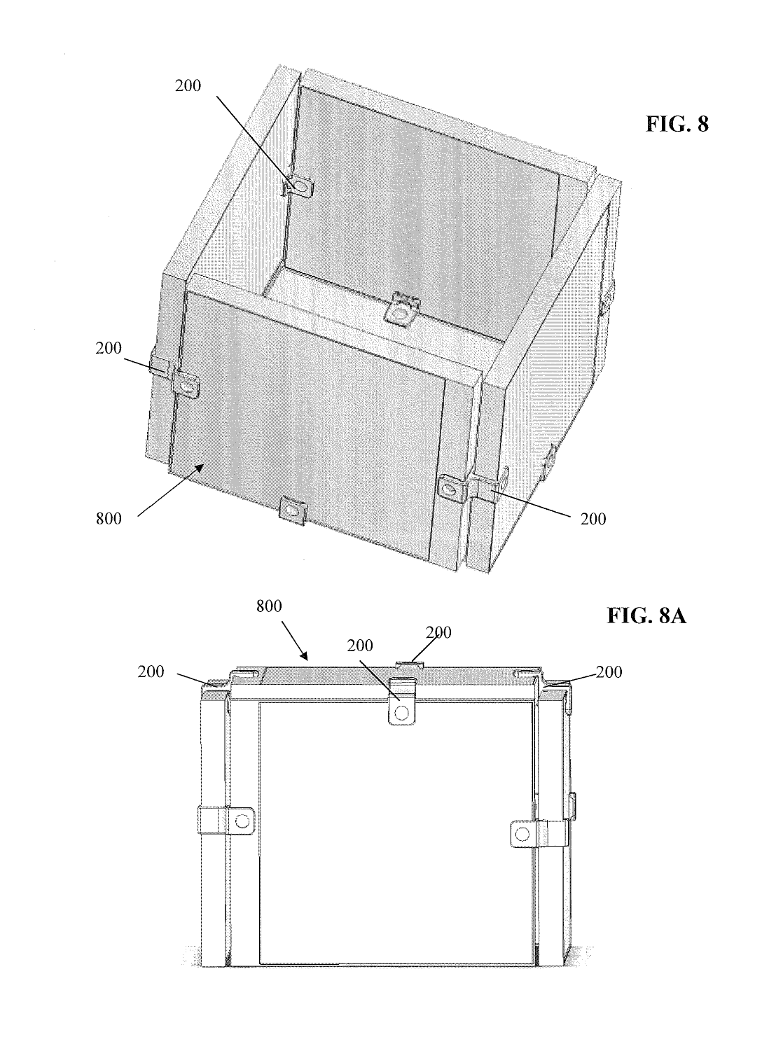

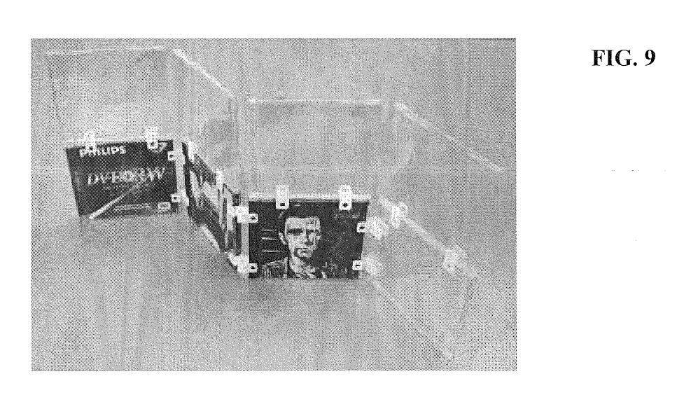

FIGS. 2 and 2A show a second removably attachable clip 200 with means to attach to two opposing CD cases such that the case faces are primarily perpendicular and two case edges are primarily aligned when fully secured. The preferred embodiment is shown with the exterior of back 202A offset from the exterior of arm 231. An alternate flush version is shown in FIG. 5B. The offset is preferred in order to enable primarily cubic constructions with multiple CD cases using only one clip design along each joint. The offset is based on the existing geometric differences in length, width, and height of a standard CD jewel case, along with the addition of clip material thickness. The clip is further optimized, evident in FIG. 2A, such that the preferred embodiment places the center plane of back 202A between the planes created by the exterior of anus 221 and 231. Cubic construction systems using multiple CD cases and clip 200 are shown in FIG. 8. The cubes are shown with one case removed for illustrative purposes only. Per FIG. 8A, the cube can be completed by assembling one case opposite and parallel to case 800 and using two or more clips 200. In general, the cubic constructions of FIG. 8 show one clip 200 used along each cube edge; however, greater or fewer number of clips may be used depending on the desired strength, stability, and aesthetic construction.

Per FIG. 2, a portion of back 202B is shown integral across a portion of arm 211. This reduces the amount of material used for construction and also provides necessary geometric clearances to enable ready construction of cases in three dimensions such as the box in FIG. 8. Further, since back 202B and arm 211 are integral, hole 215 is shown not to pass all the way through aim 211. This is an alternate version of hole geometry and is preferred in this instance in order to preserve aesthetic appeal of the exterior of the clip. In addition, a generous radial blend 210 is shown between backs 202A and 202B. This blend provides extra structural support between two assembled cases and further reduces the chances of clip fracture that may otherwise occur at this location if no radius feature was used. Aside from the integral backing, radial blend, and a partial hole 215 depth, all other features of the preferred embodiment of clip 200, including aim, back, and joint features, are identical to clip 100.

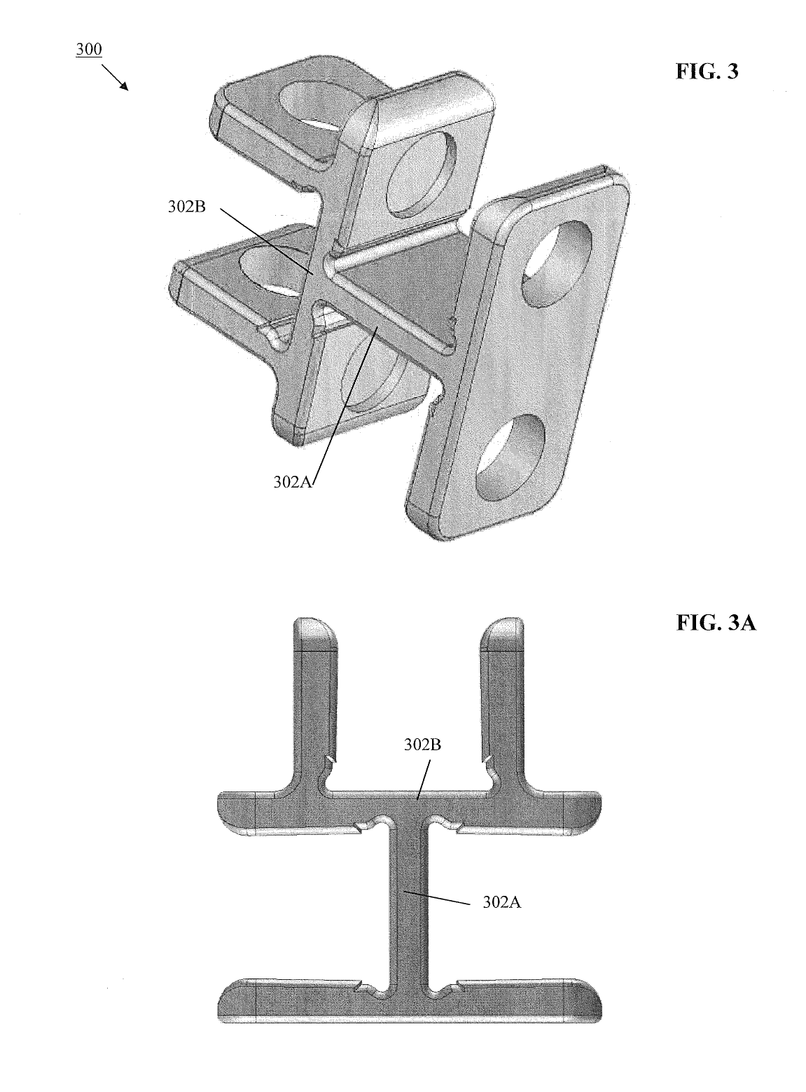

FIGS. 3 and 3A show a removably attachable clip 300 with means to attach to three opposing CD cases such that the case faces of two cases are primarily co-planar when secured and a third case is primarily perpendicular to the first two cases when fully secured. Clip 300 is primarily a hybrid of clip 100 and clip 200, symmetric about the center plane of back 302A. This feature allows clip 300 to be installed in place of or alongside clip 100 or clip 200 while allowing attachment of another CD case at this intersection. This feature readily enables larger and more complex construction systems by using only one clip. In addition, it is expected to add strength to the assembly than if a comparable geometry was assembled using only clips 100 and 200. This is due to the increased stiffness of the overall clip when a CD case is securely contained within any two opposing arms.

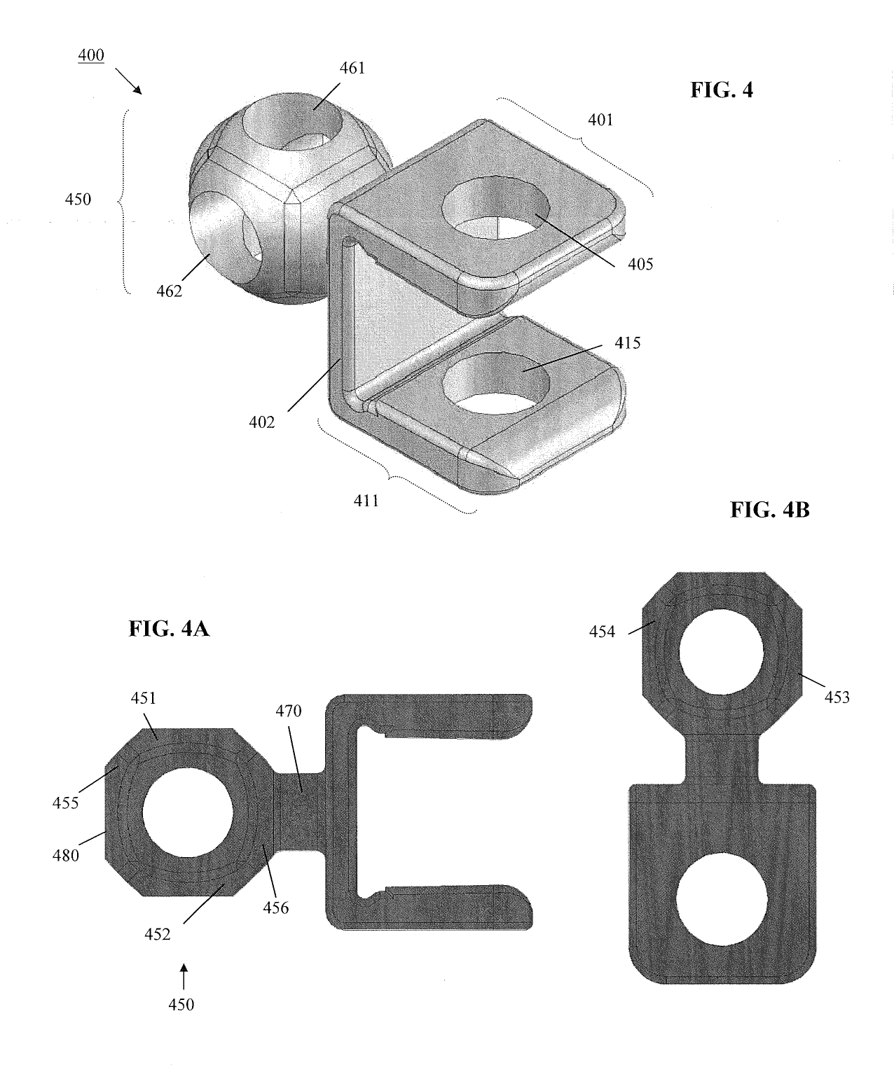

FIGS. 4, 4A, and 4B show a removably attachable clip 400 with means to securely attach to one CD case and means to adjustably mate with one other clip via an element 450 designed to snugly fill the void between two opposing clip arms in a ball-and-socket type configuration. The clip side, consisting of aims 401 and 411, back 402, and other associated features, are preferably identical to the same features in clip 100. The element 450 is preferably spherical in contour and may contain multiple raised surfaces in order to, as a minimum, provide a ratcheting feature when the element is rotated. The preferred embodiment in FIG. 4 contains six raised spherical surfaces, 451, 452, 453, 454, 455, and 456. Each surface is identical and is established by displacing a common-sized sphere an equal amount in six orthogonal directions from a point that is preferably coincident with the midpoint of the back 402. This arrangement of spheres serves to ratchet the clip 400 relative to another clip in primarily 90 degree increments. Every 90 degrees, clip 400 settles into a semi-locked position. This allows clip 400 to be easily used in hinge applications requiring at least one constant planar orientation between any two given CD case surfaces and/or faces.

Per FIG. 4A, the element 450 is suspended from back 402 by post 470, which is preferably cylindrical with filleted points of attachment to the back 402 and element 450 for stress reduction purposes. The length of post 470 is sufficiently small to reduce component size and weight but is sufficiently large to allow clip 400 to be readily swiveled at least 180 degrees about the axis created by any two opposing arm holes in which it is captured without interference.

FIG. 4 shows holes centered through each raised spherical surface. Specifically, hole 461 passes through spherical surfaces 451 and 452 and hole 462 passes through spherical surfaces 453 and 454. The holes minimize the amount of material necessary for construction. In addition, they reduce the end-to-end height of the element 450, permitting smoother insertion between opposing arms 401 and 411. In the preferred embodiment, holes 461 and 462 are slightly smaller diameter than holes 405 and 415. Therefore, when “locked” at a 90 degree orientation between two opposing clip anus, element 450 is thereby ensured to have some material engagement within the opposing holes. In addition to element holes 461 and 462, a flat 480 of removed material is shown on raised spherical surface 455. This flat mimics the planar cuts created by holes 461 and 462 and also provides extra clearance between the element 450 and any mating clip back (for instance 402) when the two clips are fully engaged and clip 400 is swiveled about the axis created by any two opposing arm holes (for instance holes 405 and 415).

In alternate versions of clip 400, the element 400 may be completely spherical, may not contain any holes, and may utilize any combination of indents, detents, raised lips, etc. in order to reduce or increase the amount of ratcheting or locking behaviors.

The clips identified herein are preferably a grade of thermoplastic manufactured using a conventional injection molding process. In particular, the material is preferably a version of acrylonitrile butadiene styrene (ABS), but could also be a polycarbonate, acrylic, nylon, etc. The parts may also be created using any rapid prototyping process such as stereolithography (SLA), selective laser sintering (SLS), fused deposition modeling (FDM), etc. The parts may also be extruded and/or cut from plastic stock. Although not specified, the grade of plastic may also consist of any amount of post-consumer recycled plastic, from none to all. The clips can be provided in a variety of solid colors or they may be supplied with translucent colors or completely clear. Embedded and/or painted patterns may be achievable and surface textures may also be minimally altered to enhance manufacturability, visual appeal, and/or performance. In other modes of the present invention, the clips could be manufactured from alternate materials such as metal or wood, with geometries adjusted accordingly.

FIG. 5 shows alternate versions of clips. The construction system is not considered limited to embodiments shown herein. One alternate element not shown is a piece with at least one location consisting of an exterior geometry that mimics the outer contour of a CD case, thereby allowing use of the construction set with or without CD cases. Furthermore, the piece could be used to adapt the clip geometry to attach to other media cases, such as to non-standard CD cases.

FIG. 5C shows a double ball-like piece that also contains opposing cylindrical cavities for snap-on capture of a standard cylindrical object, such as a pen or pencil. The piece, alone or with other variations, could be further refined to optimize a construction system using mostly or only standard cylindrical-like members like pens and pencils.

Another piece is envisioned for said construction system that can be snap-fit completely through any aim hole. The piece would clearly only fit onto through-wall holes and would be intended to snap fit by inserting through the exterior or any arm wall. Further, this piece could be configured to contain an opposite end consisting or any number of clip or rotational elements discussed herein. In addition, this piece could be configured to allow axial mounting of a CD relative to the aim hole. This would allow ready display of any CD for aesthetic appeal or as a wheel-like structure when used in a toy capacity.

In another embodiment of the present invention, the clips may be configured to serve primarily as accessories to mostly a single CD case. For example, clips may be configured and/or attached to other elements intended merely to position a case on a table as like a typical business card holder. In this example, one end of the clip would secure to the CD case and the remaining clip geometry, alone or in parallel with the geometry with CD case, would provide a foundation to stand the case at some desired angle. Furthermore, the clip geometries may be made to represent anatomical features such as arms and legs, and affixed to a case in such a manner to create a likeness of a person. This example would be similar to accessories used to adapt Mr. Potato Head toys.

In another embodiment of the present inventions, the clips are configured to snap onto other electronic media cases, such as cassette tape cases, DVD cases, and thicker or thinner CD cases. In these instances, lips are less evident around the case edges, so the clip designs would likely need to be altered from the preferred versions herein so as to increase the frictional force that would retain the case in place.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Further, although elements of the described aspects and/or embodiments may be described or claimed in the singular, the plural is contemplated unless limitation to the singular is explicitly stated. The following claims are hereby incorporated into the Detailed Description, with each claim standing on its own as a separate embodiment.

I claim:

1. A construction system for joining a plurality of CD cases comprising:
a plurality of component clips, wherein each component clip defines a front recess formed by a front upper arm, a front lower arm and a front support back connecting the two front arms, wherein the front arms are generally parallel; and
wherein each clip further defines a groove on each of the two front arms adjacent to the support back within the front recess.

2. The construction system of claim 1 wherein each of the grooves is dimensioned to receive a raised lip on an edge of the CD case; and wherein the distance between the two front aims spans a dimension of the CD case.

3. The construction system of claim 2, wherein each of the front upper arm and the front lower arm define a generally circular aperture.

4. The construction system of claim 2, wherein each of the two parallel arms further comprise opposing generally axial-symmetric apertures, the apertures sized to receive a generally spherical ball having a nominal diameter slightly larger than the dimension of the CD case.

5. The construction system of claim 2, wherein each clip further defines a rear recess, wherein the rear recess is defined by an upper rear arm and a lower rear arm generally parallel to each other and an opposite side of the front support back and wherein each of the upper and lower rear arms defines a groove adjacent to the opposite side of the front support back within the rear recess; wherein the front upper arm is in the same plane as the rear upper arm; the front lower arm is in the same plane as the lower rear arm; and wherein the distance between the two rear arms spans the dimension of the CD case.

6. The construction system of claim 2, wherein each clip further defines a rear recess, wherein the rear recess is defined by an upper rear arm and a lower rear arm generally parallel to each other and a rear support back; wherein each of the upper and lower rear arms defines a groove on each of the rear arms adjacent to the rear support back within the rear recess; the rear support back extends perpendicular to the front support back; the rear support back extends parallel to the front upper arm; and the rear upper arm integral with a portion of the front support back; and wherein the distance between the two rear arms spans the dimension of the CD case.

7. The construction system of claim 5, wherein each clip further defines a third recesses; the third recess formed by a third upper arm extending outwardly from the front upper arm, a third lower arm extending outwardly from the rear upper arm, and a third back formed from portions of the front upper arm and rear upper arm; the third arms being disposed parallel to the front support back; wherein each of the third arms defines a groove adjacent to front upper arm and rear upper arm within the third recess; and wherein the distance between the two third arms spans the dimension of the CD case.

8. The construction system of claim 2, wherein each clip further defines a ball on a stem wherein the stem extends outwardly from the clip; and the ball having a nominal diameter slightly larger than the dimension of the CD case.

9. The construction system of claim 8, wherein the ball is generally spherical in contour.

10. The construction system of claim 9, wherein the generally spherical contour is broken by five orthogonal slices.

11. The construction system of claim 8, wherein the ball defines four cylindrical apertures each of which being orthogonal to the stem, the axes of the cylindrical apertures extending through the center of the ball; and the ball has a fifth circular aperture opposite the stem.

12. The construction system of claim 11, wherein the generally spherical contour further comprises multiple raised surfaces.

13. A construction and CD case system, comprising:
a generally cubic assembly of six CD cases assembled by at least one component clip along each of twelve edges of the cubic assembly, each component clip defining two orthogonal recesses, each recess having frictional means integral to the recess able to releasably seize raised lips found on two opposing edges of each CD case.

14. A method of using a component clip, the method comprising the steps of:
orienting the component clip and a CD case, the component clip having a first recess folioed by two opposing parallel arms and a support back connecting the two opposing arms, a groove on each of the two opposing arms, the grooves adjacent to the support back, such that the CD case is adjacent but not within the first recess; and
sliding the CD case into the first recess so that at least one lip on the CD case is received in one of the grooves.

15. A construction system to join CD cases, the system comprising component clips having at least one CD recess; the at least one CD recess having frictional holding means to releasably grip a raised lip on the CD case.

16. The construction system of claim 15, wherein the frictional holding means includes at least two grooves within the at least one CD recess.

17. The construction system of claim 16, wherein each of component clips defines two opposing generally axial-symmetric apertures, the apertures sized to receive a generally spherical ball having a nominal diameter slightly larger than a dimension of the CD case.

18. The construction system of claim 17, wherein each of component clips further comprises a ball on a stem; the stem extending outward from the component clip; and the ball having a nominal diameter slightly larger than the dimension of the CD case.

19. The construction system of claim 18, wherein the ball defines four cylindrical apertures each of which being orthogonal to the stem, the axes of the cylindrical apertures extending through the center of the ball; and the ball has a fifth circular aperture opposite the stem.

20. The construction system of claim 19, wherein the ball has a generally spherical contour and multiple raised surfaces.
